(19) United States
(12) Patent Application Publication
(10) Pub. No.: US 2016/0180701 A1
(43) Pub. Date: Jun. 23, 2016

(54) HAND GESTURE CONTROL SYSTEM

(71) Applicant: Clayton R. Golliher, Tujunga, CA (US)

(72) Inventor: Clayton R. Golliher, Tujunga, CA (US)

(21) Appl. No.: 14/581,972

(22) Filed: Dec. 23, 2014

(51) Int. Cl. G08C 17/02; G06F 3/03; A63H 30/04; G06F 3/01

(52) U.S. Cl. CPC G08C 17/02; G06F 3/017; G06F 3/0304; A63H 30/04; G08C 2201/32

(57) ABSTRACT

A user-interface module co-operates with a processor/transmitter to form a control system that can remotely control a moving object in response to human hand gestures. The module includes at least one emitter element radiating energy and at least one sensor element monitoring energy reflected from a hand intercepting a portion of the radiated energy and gesturing in a manner to indicate desired control. The module sends a detected energy signal to at least one input channel of an RC processor/transmitter controlling the moving object. With a toy helicopter as the moving object, a single-channel module can enable RC of rotor speed and thus vertical travel and altitude proportional to hand height, enabling takeoff, hovering and landing. Additional RC channels can be incorporated in a module for gesture RC of additional functions including horizontal travel and steering.

### PRIORITY

Benefit is claimed under 35 U.S.C. 119(e) of pending provisional application 61/920,365, filed Ser. No. 12/23/2013.

### FIELD OF THE INVENTION

This invention is in the field of control systems, more particularly control systems directed to RC (remote control) of electric motor power systems in aircraft, particularly unmanned small scale model and toy helicopters, via space-transmitted energy delivering RC commands originated in the form of gestures of a user's empty hand.

### BACKGROUND OF THE INVENTION

Wireless RC of a moving object has been known and practiced for many years and has become highly developed as exemplified by the advent of unmanned drone aircraft. Typically, in all categories of electric control technology including wired, wireless, remote and local, a user initiates control commands via tactile electro-mechanical “hands-on” (or foot-actuated) manipulation of user-interface control devices including proportional controls such as joysticks, sliders and rotary knobs of potentiometers and variable resistors, etc., and binary digital switching controls such as keyboards, key pads, pushbuttons, toggle switches, etc.

The hobby of model aircraft has benefited greatly from advances in wireless RC development, particularly in the categories of model and toy helicopters continuing to increase in public popularity due to ergonomic innovations and improvements which contribute greatly to the convenience, safety and recreational benefits from these hobbies in addition to their educational and training value. Ongoing development efforts in the technology of toy helicopters and RC thereof continue to provide increased convenience, performance and safety at lower cost.

Further technical challenges are encountered in attempting to RC a small-scale or toy helicopter even if it is equipped with costly state-of-the-art omni-directional position-sensing automatic control technology. The need for such automation operating in conjunction with good RC capability becomes evident when attempting to RC a typical model helicopter with dual counter-rotating rotors running at equal constant speed for the desired hovering altitude and with horizontal travel controls set and held at neutral. Without position-sensing control automation, excessive erratic sway and random travel drift off station are almost inevitable, due mainly to unpredictable self-generated and/or environmental air currents aggravated by nearby buildings, walls or other objects. Accomplishing hand-gesture RC capability that simulates or at least approaches the control capabilities available to an onboard pilot poses even further heretofore unfulfilled technical challenges and needs that are hereby addressed by the present invention.

### DISCUSSION OF KNOWN ART

U.S. Pat. No. 2,281,928 issued Feb. 28, 1928 to Leo S. Theremin for METHODS AND APPARATUS FOR THE GENERATION OF SOUNDS, originated in Russia in 1919, teaches control of a musical instrument, e.g. regarding frequency (pitch) and loudness, from gestures of at least one empty hand in open space above control elements that make the space an electrostatic charge field of a capacitance in an oscillator circuit caused to vary in frequency from the influence of hand movements because the dielectric constant of the hand is much greater than that of the surrounding charge field medium.

U.S. Pat. No. 6,27Wang9,777 issued Aug. 21, 2001 to Goodin et al for DISPENSING CONTROL SYSTEM discloses a system for controlling operation of a device in response to the presence of a human body part, utilizing a theremin for such detecting.

U.S. Pat. No. 7,100,866 B2 to Rehkemper et al for CONTROL SYSTEM FOR A FLYING VEHICLE utilizes on on-board proximity sensor wherein the sensor element operates in a known basic binary logic mode, i.e. switching a command signal between two states (on/off) depending on the criteria of whether or not a reflected signal is received.

U.S. Pat. No. 8,639,400 B1, issued Jan. 28, 2014 to Wang for ALTITUDE CONTROL OF AN INDOOR FLYING TOY, in each of three independent claims, calls for sensing vehicle position, at least altitude, by a proximity sensor having a light beam directed from the vehicle toward a surface, and repeatedly “increasing said light intensity I”, and responding to the binary criteria “ . . . if said reflected signal is received”. by adjusting a counter rate (e.g. rotor speed). The specification at column 8, lines 3, 17, describes using a hand-held controller as a proximity sensor for “ . . . gesture mode control in which player can tilt the transmitter . . . ” relative to a reflecting surface.

No RC systems are known for controlling moving objects, particularly toy helicopters, utilizing empty-hand gestures in the manner of the present invention.

### OBJECTS OF THE INVENTION

It is a primary object of the invention to enable RC of a moving object in response to gestures of an RC user's hand.

It is a further object for the RC user-interface module of the invention to be made to co-operate with a known RC processor/transmitter to form an RC system wherein the module actuates at least one RC channel thereof for hand-gesture RC of the moving object.

It is a further object to incorporate in the module at least one proximity sensor unit including an emitter element radiating an energy beam and a sensor element responsive to a reflected energy beam received from the user's hand reflecting the radiated energy beam,

### SUMMARY OF THE INVENTION

The foregoing objects have been met by the present invention of an user-interface preprocessor module that co-operates with a known processor to form a control system that can remotely control a moving object in response to human hand gestures. The module includes at least one emitter element radiating energy and at least one sensor element monitoring energy reflected from a hand intercepting a portion of the radiated energy and gesturing in a manner to indicate desired control. The module sends a detected energy signal to at least one RC input channel of a known RC processor/transmitter controlling the moving object. With a toy helicopter as the moving object, a single-channel module co-operating with a processor/transmitter can enable wireless RC of rotor speed and thus vertical travel and altitude proportional to hand height, enabling takeoff, hovering and landing. Additional RC channels can be incorporated in a module for gesture RC of additional functions including horizontal travel and steering.

### BRIEF DESCRIPTION OF THE DRAWINGS

FIG. 1 is a symbolic/functional-block diagram of a single-channel RC system including a user-interface module providing proportional RC commanded by gestures of a user's hand, in a basic illustrative embodiment of the present invention.

FIG. 2 is a three-dimensional functional representation of the hand-gesture RC user interface module of FIG. 1 with the module enclosure partially cut away to show the sensor element inside.

FIG. 3 is a plan view of a horizontal surface surrounding the sensor element of FIG. 2.

FIG. 4 is a three-dimensional functional representation of a hand-gesture RC user-interface module, based on the module in FIG. 2, upgraded to a preferred embodiment providing a 3-channel proportional RC capability commanded by user hand gestures.

FIG. 5 is a plan view of a horizontal surface surrounding the two sensor elements of FIG. 4.

FIG. 6 is a three-dimensional functional block diagram showing a 4 channel RC system remotely controlling a helicopter by RC commands originated by a user's both hands, each gesture-controlling a corresponding one of two RC-user-interface modules in accordance with the present invention.

### DETAILED DESCRIPTION

FIG. 1 is a symbolic/functional-block diagram of a single-channel RC system illustrating a basic embodiment of the present invention wherein a user-interface module 10 enables RC command by gestures of a user's hand. In module 10, an emitter element 12 radiates energy in an upward beam 14′ which is intercepted and reflected by the user's hand 16 to return as energy beam 14″ reflected downward onto a sensor element 18 which detects the reflected energy received and delivers a detected signal at node 20, i.e. the output of module 20 and the input of a processor 22, where the detected signal is processed into a control signal containing command data in 2-6 channels be sent from at the output of processor 22 via a link 24 to the controlled object 26.

If the controlled object 26 is in a stationary location, link 24 can be a direct wire connection as shown; otherwise RC of moving objects typically requires link 24 to be a wireless link including a transmitter at the output of processor 22 radiating, typically at RF (radio frequency), to a compatible receiver at the remote moving location of the controlled object 26. (see FIG. 6)

Emitter element 12 is typically an LED (light-emitting diode) radiating at IR (infra red) frequency. Other types of emitter element could be utilized, and the operating frequency can be anywhere in a spectrum from audio, through RF and microwave to light. However, IR is preferred for its line-of-sight advantages, and LEDs are preferred for their high level of technological development, reliability and efficiency. The sensor element 18 could be any of several types of light sensitive devices including active and passive photocells, cadmium sulfide light-dependent resistors, photo voltaic cells, photo conductive strips, etc. A light-sensitive semiconductor diode or transistor, optimized to operate at the same IR frequency as the emitter element 12, offers good efficiency and reliability.

Hand gesture control actuates sensor element 18 only when the reflector (hand 16) is located within a cone-shaped working region starting from a lower limit located closely above module 10 and expanding as it extends upwardly, sized by inherent beamwidth angles of the emitter and sensor elements and any modification by lenses, apertures or nearby structure. The upper boundary of the working region is limited by the power level of energy radiated by emitter element 12 and system sensitivity which is in turn limited by background noise at the minimum signal level threshold of sensor 18.

Anywhere within this working region, energy radiated from emitter element 12 can be intercepted by a reflector such as hand 16 and reflected back down onto sensor element 18 so as to enable module 10 to produce a detected signal at node 20 from which processor 22 formulates channel command data that is relayed to control mechanisms of the controlled object 26, thusly responsive to reflector movements, i.e. gestures of the user's hand 18, in accordance with the present invention

FIG. 2 is a three-dimensional functional representation of the hand-gesture RC user interface module 10 of FIG. 1 with its enclosure partially cut away at opening 10A to show the sensor element 18 inside, surrounded by the enclosure of module 10 which serves to shield sensor element 16 against energy radiated by emitter element 12 and from ambient radiant noise energy. An aperture 10B acts in the manner of an optical mask or a a pinhole camera lens, sizing and shaping beam 14″ as it enters the enclosure of module 10.

Optionally, an optical lens could be located above sensor element 18 and/or emitter element 12 for enhancing system efficiency to increase the upper boundary height limit of the working region and/or reduce the required working power level of emitter element 12.

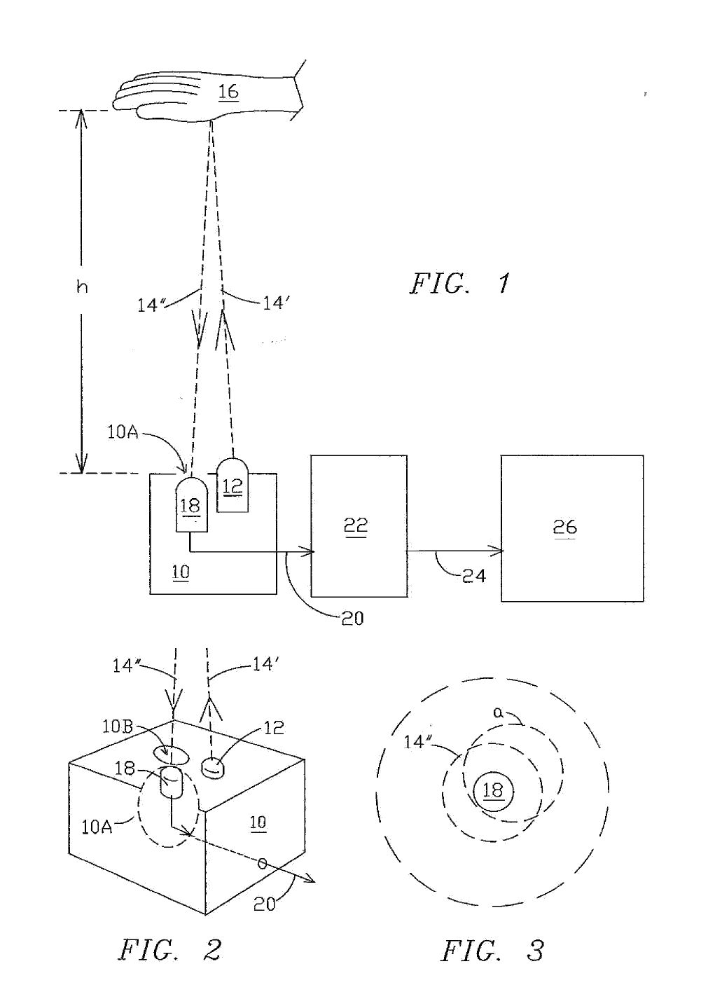

FIG. 3 is a plan view of a circular portion, indicated by the dashed circular outline, of a horizontal surface of structure supporting and surrounding the sensor element 18 of FIG. 2 inside the enclosure of module 10. The circular “spotlight” outline of beam 14″, as shaped and sized by aperture 10B (FIG. 2), or by a lens, will remain concentric with sensor element 18, as shown, as long as the reflecting surface (hand 16, FIG. 1) is held approximately centered on a vertical working beam axis of sensor element 18.

Moving hand 16 away from this axis within the working region will shift the “spotlight” accordingly, e.g. as indicated by circle “a”, which, encompassing sensor element 18, represents an control system condition that remains fully functional as “margin of error” tolerance. However the output of sensor element will fall to zero and proportional analog RC operation will become interrupted by displacement of the hand 16 off-axis in any direction to an extent that the off-axis “spotlight” of beam 14″ no longer encompasses sensor element 18.

Such on-off switching can be utilized in the most basic form of the invention wherein a single sensor element 18 is operated as a binary 0/1 switch providing an output of zero volts for binary “0” whenever no reflected energy is sensed, and switching the output to a detected DC output voltage for binary “1” upon receiving reflected energy. The detected DC output, whatever its voltage, is amplified if necessary and buffered to a standard voltage called for in a binary signal protocol: “1” whenever hand 16 is moved into the working region, switching to send “0” whenever hand 16 is moved sufficiently out of the working region in any direction; a horizontal gesture is typically preferred and utilized in this basic binary mode, wherein hand gestures will have no effect as long as the hand remain within the working region. An analog proportional channel can be controlled simultaneously by the same hand, but would require “dead man throttle ” capability to hold the current analog settings whenever the hand is moved/held out of the working region to send binary “1”.

Alternatively and preferably, a single-sensor module 10 as in FIGS. 1-3, is operated in an analog proportional mode that provides a variable detected output proportional to hand height, enabling smooth, continuous proportional control desired for critical functions such a throttle and motor speed.

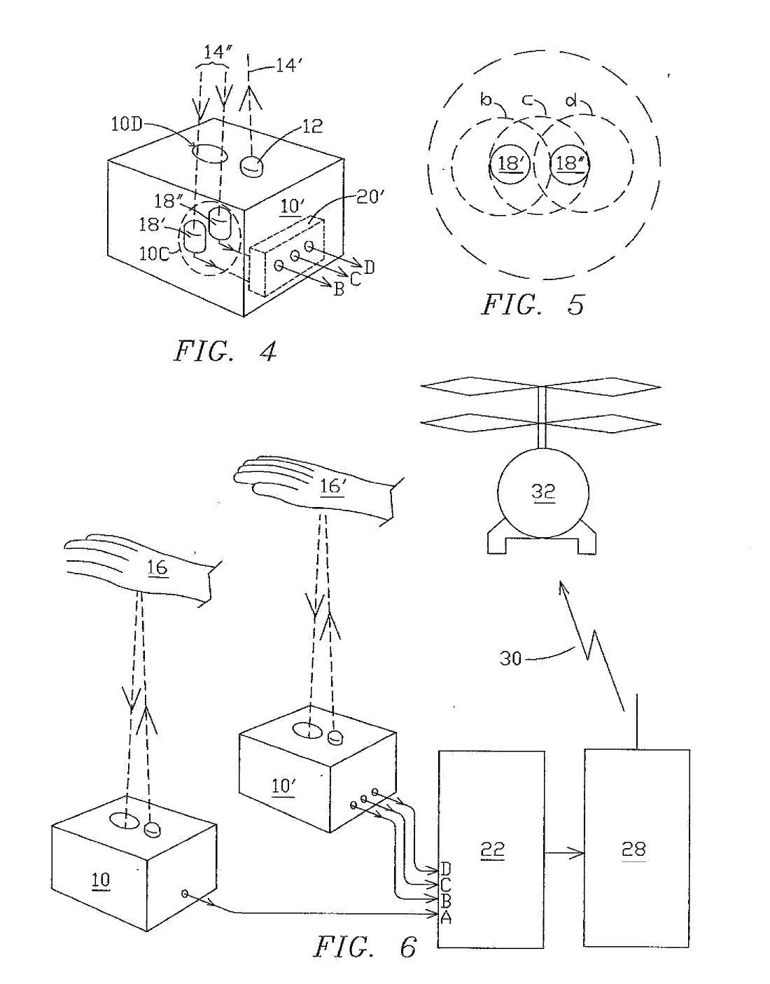

FIG. 4 is a three-dimensional functional representation of a hand-gesture RC user-interface module 10′, a step-up version of module 10 of FIG. 2, upgraded to a preferred embodiment. A portion of the energy radiated in beam 14′ by emitter element 12 is reflected back via reflected beam 14″ onto two sensor elements 18′ and 18″ shown in cutaway region 10C, located at a designated distance beneath an aperture 10D or lens, co-operating via a logic multiplexer 20′ to provide command data in three channels: B, C and D. These may be analog proportional or binary digital or combination thereof for any or all channels. Logic multiplexer 20′ can be designed for compatibility with the capabilities and protocols of a particular known brand processor 22 (FIG. 1).

FIG. 5 is a plan view of a horizontal surface surrounding the two sensor elements 18′and 18″ of FIG. 4. The central dashed circle c indicates the extent of reflected beam 14″ forming a “spotlight” that encompasses and illuminates both sensor elements 18′ and 18″, corresponding to hand 16 (FIGS. 1, 6) being located on the vertical working beam axis such that the energy levels detected by sensor elements 18′ and 18″ will be substantially equal.

In an exemplary 3 channel control system, logic multiplexer 20 is designed with logic that automatically selects either sensor element 18′ or 18″, whichever is developing higher detected DC voltage, as the source for channel C to operate as the main channel providing proportional gesture-originated control in essentially the same manner as described above for a single channel module 10 (FIGS. 1-3).

For simple vehicle control, channel C could provide proportional throttle/velocity/motor-speed control, either as forward only, with zero (stop) at one end of the range, or forward/reverse, with zero (stop) at or offset from mid-range. Channels B and D could provide binary left/right vehicle steering (or heading) control actuated by the user moving hand 16 far enough off-axis to shift the circular reflected beam “spotlight” to location “b” or “d” as shown in FIG. 5, i.e. spotlighting only one of the two sensor elements 18′, 18″, thus disabling the other so as to provide binary command data for RC channels B and D while retaining and simultaneously utilizing full analog h-variation RC performance from the active sensor element automatically selected for the main RC channel C. Turning could be implemented as incremental steps, e.g. each 5 degrees, left or right, callable as a binary activation pulse that alters the turn direction by a step each time hand 16 is gestured off-axis, left or right.

Optionally a “dead man throttle” feature could be incorporated to reset the three RC channels to neutral default settings in the event of input system failure, e.g. absence of a reflected energy beam 14″ as indicated by zero output from both sensor elements.

Additional gesture-originated control capabilities can be facilitated by additional sensor elements using various multiplexing, logic, and/or electro-optical techniques e.g. special aperture beam-shaping, optical geometry configurations and/or addition of one or more optical lenses above sensor and or emitter element(s).

FIG. 6 is a three-dimensional functional block diagram showing a 4 channel RC system remotely controlling a helicopter 32, by RC commands originated by a user's both hands 16 and 16′, each gesture-controlling a corresponding one of two RC-user-interface modules 10 and 10′ in accordance with the present invention. The single output of module 10 and the three outputs of module 10′, both configured and operating as described above, send input, as shown, to the known main RC processor 22, which sends the RC command data via transmitter 28 and its radiated energy link 30, typically at a designated radio frequency, to the controlled helicopter 32.

In a basic illustrative embodiment directed to model and toy helicopters, the left hand 16 gesture-controls vertical travel and thus altitude via the single RC channel of module 10, while the right hand 16′ gesture-controls horizontal travel, including speed and steering, via the 3 RC channels of module 19′.

Module 10 is made and arranged to provide single-channel RC, as described above in connection with FIGS. 1-3, enabling the user's left hand 16 to control the altitude of the helicopter 32 in proportion to the height of left hand 16 above the sensor element of module 10, typically by varying the rotational speed and/or blade pitch of the rotor(s), and thus the rotor lift force, to initiate vertical travel upward or downward from a hover altitude at which the lift force equals the weight of the helicopter 32, and at which helicopter 32 tends to hover or travel as long as the left hand 16 is held steady at the corresponding height.

Module 10′ is made and arranged to provide 3-channel RC, as described above in connection with FIGS. 4 and 5, enabling the user's right hand 16 to act as a throttle controlling the velocity of forward horizontal travel of helicopter 32 in proportion to the height of right hand 16′ above the sensor element of module 10′.

An optional “dead man throttle” feature as described above in connection with FIG. 5, incorporated into the left hand RC channel A signal path of module 10 and/or processor 22, would allow the user to remove left hand 16 out of the working region, leaving a default setting to hold at hover altitude, thus allowing the left arm to rest and allowing the user to concentrate on right-hand-gesture horizontal navigation until further need to resume left hand control of altitude.

Indoors in a room with an 8′ to 10′ ceiling, the lift force of the rotors increases considerably as the altitude is reduced approaching the floor due to the increasing reaction of the downdraft impacting the floor, the RC channel (3) altitude=controlled helicopter will tend to seek and move vertically to a hover altitude at which the lift force of the rotors (depending on their rotational velocity) is held equal to the helicopter's weight.

However, in attempting to hover in place without benefit of the control functions of channels (1) and (2), there would be a tendency to sway and drift horizontally out of place in random directions due to environmental and self-generated air current disturbances influenced by nearby walls and/or other objects. Due to environmental and self-generated air currents, etc., hovering stably and accurately in place typically requires horizontal stabilization and, in the absence of sophisticated onboard positional automatic control, will demand ongoing attention and control compensation from a pilot, either onboard or by RC. Otherwise, even if hovering altitude can be maintained, excessive swaying and horizontal drift are virtually inevitable.

In single-rotor helicopters, inherent counter-rotation of the fuselage, in reaction to the rotation of the rotor, is compensated by a tail-located vertical-plane fan controlled in speed, (optionally controlled automatically in conjunction with a gyro-compass) to cancel counter-rotation to maintain a constant desired heading, or altered in speed to allow counter-rotation for the purpose of altering heading direction. In helicopters with co-axial shafted dual stacked rotors, fuselage counter-rotation is inherently neutralized by the balance of equal rotor speeds. with the option of providing steering control by introducing a rotor speed differential that will cause the fuselage to rotate to a desired new heading direction, while holding an average of the rotor speeds that maintains the desired rotor lift.

Modules 10 and 10′ could be integrated into a single module with fixed hand-to-hand spacing, however two modules are advantageous not only for the benefit of adjustable spacing for user comfort, but also the flexibility for creating special RC systems using either module alone in other modes, e.g. sharing selected RC channel capabilities in co-operation with the known processor 22, interchanging the locations of modules 10′ and 10″ for a left-handed user, forming a 2-channel RC system with two single channel modules 10, or forming a 6-channel system with two 3 channel modules 10″.

The principle of the invention can be practiced in many other possible modes including manipulating a compact module embodiment held in one hand while directing the emitted beam 14′ either to a fixed reflecting surface such as a wall or floor, or even using the other hand as the reflector and varying the beam length by varying the hand-to-hand spacing in the manner of an accordion type musical instrument.

Multi-sensor-element module IR embodiments have the potential of gesturing to deliberately energize more than one sensor simultaneously to provide additional control channels by binary combinations, assuming appropriate optical selectivity. As shown in FIG. 5, a circular “spotlight” can be manipulated to selectively encompass and illuminate either sensor element, 18′ or 18″, or both simultaneously, enabling 3-channel call-up (b, c=bd, d). Similarly a triangular trio of sensor elements can enable 7-channel call-up (a, b, c, ab, bc, ca, abc), more than adequate for toy/model helicopter RC, typically using 4-6 channels. A square quad array could enable 13 channel call-up (a, b, c, d, ab, bc, cd, da, abc, bcd, cda, dac, abcd),

To serve as processor 22, known brands are available with typically 2 to 4, 5 or 6 RC channels for standard toy helicopters controlled in various modes, e.g.:

(1) Using both hands, the left hand over one sensor element and the right hand over another sensor element, the right-hand controls the throttle of the vehicle by going up-and-down in the proximity detector beam. An upward thrust of the hand increases the throttle and a downward thrust of the hand decreases the throttle. The left-hand controls the forward motion of the helicopter, and the right and left hands together cause a turning motion of the helicopter, left or right, depending on whether the hands move left or right. On the left-hand side of the controller three sensors are in a V-type formation, one in front of the hand, one to the left, and one to the right. As the operator moves an outstretched hand forward covering the first middle sensor, this causes the helicopter to move forward. Covering the left hand sensor causes the helicopter to rotate to the left. Covering the right hand sensor causes the helicopter to rotate to the right. Covering the right hand sensor and the forward sensor at the same time with the left-hand causes the helicopter to go forward and travel to the right. As the operator covers the forward sensor and the left sensor at the same time, it causes the helicopter to go forward and travel to the left at the same time. The operator's right hand is making adjustments to the up-and-down travel of the helicopter.

(2) With the second controller type the right hand operates the same as the first type. However, the operator's hand is extended straight forward, intercepting the first beam. Raising hand about 4 inches causes the helicopter to rotate to the right. Raising the hand the next 4 inches commands the helicopter to rotate the left. Moving the hand forward covers the second detector and causes the helicopter to go forward. Moving the hand up and down can control left and right motion and then forward motion by raising the hand another ˜4 inches.

(3) With the third type of controller for 2 to 4 channel standard helicopters, all throttle and directional control is done with only the right hand. As the hand moves up the helicopter rises; as the hand is lowered the helicopter is lowered. As a hand comes up and moves forward the helicopter goes forward. As the hand rotates to the left the helicopter rotates to the left. As the hand rotates to the right the helicopter rotates to the right and so on.

Again, the vehicles could be of any type. In addition, objects that have a three dimensional range of motion could be similarly controlled in this remote manner.

All of these controllers could be situated on a belt, attached to the front to allow the operator to walk around and have mobility. Alternatively, they could be on a type of strap around the neck and so on.

The principles and spirit of the present invention can be readily applied to both full-sized and scaled-down objects, both fixed and moving, and are particularly applicable as an entertaining and intuitive way of remotely controlling model helicopters and other motion toys.

The key system performance characteristic is the proportionality, i.e. the detected DC voltage v from sensor element 18 as a function of the height h of hand 16 or other reflector above the sensor element 18 (i.e. length of reflected beam 14″). A hypothetical system as in FIG. 1 may be analyzed mathematically based on the principle of physics that radiated energy p from a source of power P diminishes inversely with travelled distance squared (p/P=D/d̂2=d̂−2) and the principles of electricity: I=V/R (Ohm's law)) where I is current, V is voltage and R is resistance, P=V*I thus P=V̂2/R, thus, with R held constant, P is proportional to V̂2 and V is proportional to P̂−2 (square root of P).

The invention may be embodied and practiced in other specific forms without departing from the spirit and essential characteristics thereof. The present embodiments are therefore to be considered in all respects as illustrative and not restrictive, and all variations, substitutions and changes which come within the meaning and range of equivalency of the claims are therefore intended to be embraced therein.

What is claimed is:

1. A remote control system comprising;
a first user-interface module;
an emitter element in said module radiating energy therefrom;
a live empty human hand, intercepting a beam of the energy and consequently reflecting a portion of the energy toward said module;
a first sensing element, in said module, located near but shielded from the emitter element, enabled to detect energy reflected from said hand and originate therefrom a first detected-energy signal;
a processor, co-located with said module, having a first input channel “A” receiving, as input, the first detected-energy signal, and processing the first detected-energy signal so as and to provide, as output, a control signal containing command data;
a controlled object equipped with control mechanisms and means to receive the command data and activate the control mechanisms accordingly;
whereby gestures of said user's empty hand are enabled to command single-channel control of said controlled object.

2. The remote control system as defined in claim 1 further comprising;
preprocessing circuitry made and arranged to modify the first detected energy signal as required for compatibility with input requirements of said processor.

3. The remote control system as defined in claim 1 further comprising;
a transmitter, co-located with said processor, receiving, as input, the processor output signal containing the command data from said processor, and transmitting the control command data to said controlled object via a radiated energy link; and
a receiver, in said controlled object, providing the means to receive the command data and activate the control mechanisms accordingly.

4. A remote control system as defined in claim 1 further comprising;
a second sensing element in said module, located near but shielded from the emitter element, enabled to detect energy reflected from said hand and originate therefrom a second detected-energy signal;
said processor having a second input channel “B” receiving, as input, the second detected-energy signal and processing this received input signal in a manner to formulate and include channel B control commands in the remote control signal; and
said controlled object receiving an input signal representing the remote control signal including the channel B control commands and reacting responsively thereto by controlling functional capability in accordance with the channel B remote control commands;
whereby gestures of said user's empty hand are enabled to command remote control of channel-B-designated controllable functional capability of said controlled object.

5. The remote control system as defined in claim 4 further comprising;
a second preprocessor, in said module, receiving input from said second sensor element and preprocessing this input to provide as output, the second detected-energy signal, preprocessed as required for compatibility with channel B input requirements of said processor.

6. The remote control system as defined in claim 4 further comprising;
a transmitter, co-located with said processor, receiving, as input from said processor, a control signal including the channel A and channel B command data, and transmitting the command data to the controlled object via a radiated energy link; and
a receiver, in said controlled object, receiving the remote control signal via the transmitted link and acting to command functional capabilities of said controlled object in accordance with received channel A and channel B control commands;
whereby said remote control system enables gestures of said user's empty hand to command said controlled object by wireless 2-channel remote control.

7. The remote control system as defined in claim 2 further comprising;
a second user-interface module similar to said first user-interface module, similarly including an emitter element, and at least one sensing element inputting a preprocessor; and
a second live empty human hand, intercepting a beam of the energy and consequently reflecting a portion of the energy toward said second module;
whereby said remote control system enables gestures of each of the users two hands to each control a designated set of control mechanisms in multiple control channels.

8. A user-interface module, for hand-gesture-originated control, comprising;
an emitter element in said module radiating energy therefrom;
a live, empty human hand, intercepting a beam of the energy and consequently reflecting a portion of the energy toward said module; and
a first sensing element, in said module, located near but shielded from the emitter element, enabled to detect energy reflected from said hand and originate therefrom a first detected-energy signal serving as input to a processor in a control system;
whereby gestures of a user's hand are enabled to command single-channel control of a controlled object.

9. A method of originating remote control command data from gestures of a user's empty hand, comprising the steps of:
radiating energy from a an emitter element in a first module;
monitoring for reflections of the radiated energy using an energy-sensitive sensor element, located near the emitter element; capable of providing a detected energy signal ;in response to detecting a reflected portion of the radiated energy; and
intercepting a portion of the radiated energy with a live empty human hand so as to reflect energy back to the module location;
the sensor element sensing energy reflected from the hand; and consequently responding by providing a detected energy signal;
moving the hand in gestures that each expectedly alters the reflected energy and thus the detected energy signal and command data derived therefrom; and
utilizing the command data, in accordance with a predetermined protocol, as operational basis enabling a control system to command control mechanisms of a controlled object from gestures of a user's empty hand.

10. The method of originating remote control command data as defined in claim 9, wherein the controlled object is a helicopter, comprising the further step of;
transmitting the command data via a radiated energy link to a receiver aboard the helicopter made and arranged to actuate the helicopter's control mechanisms accordingly. thus enabling wireless remote control of the helicopter from gestures of a user's empty hand.

11. The method of originating remote control command data as defined in claim 10, extended to two-handed user gesture control, comprising the further steps of;
providing a second module similar to the first module, enabled to command additional control functions other than those commanded by the first module; and
simultaneously and originating control commands, pertaining to the additional control functions, from gestures of a human hand other than the hand associated with the first module, thus enabling control of the helicopter from gestures of two hands, respectively and independently, including the user's two hands, both empty.
